(19) United States
(12) Patent Application Publication
(10) Pub. No.: US 2017/0057575 A1
(43) Pub. Date: Mar. 2, 2017

(54) CRAWLER

(71) Applicant: BRIDGESTONE CORPORATION, Tokyo (JP)

(72) Inventor: Takashi MIZUSAWA, Tokyo (JP)

(21) Appl. No.: 15/242,620

(22) Filed: Aug. 22, 2016

(30) Foreign Application Priority Data
Aug. 26, 2015 (JP) 2015-166923

(51) Int. Cl. B62D 55/24

(52) U.S. Cl. CPC B62D 55/244

(57) ABSTRACT

A crawler of the present invention includes a crawler body that is formed in an endless shape from an elastic material, a main cord layer that is embedded in the crawler body, and that is configured including one or plural main cords extending along a crawler peripheral direction, and a reinforcement layer that is embedded in the crawler body, and that is configured including plural monofilament cords disposed around the entire crawler peripheral direction so as to intersect the main cord direction.

### CROSS-REFERENCE TO RELATED APPLICATION

This application claims priority under 35 USC 119 from Japanese Patent Application No. 2015-166923 filed Aug. 26, 2015, the disclosure of which is incorporated by reference herein.

### BACKGROUND

Technical Field

The present invention relates to a crawler including an internal cord layer.

Related Art

U.S. Pat. No. 7,823,988 describes a crawler including a tension belt configured including a cord extending in a peripheral direction, and a reinforcement layer configured including reinforcement cords that extend so as to intersect the peripheral direction.

The related crawler employs multifilaments for the reinforcement cords of the reinforcement layer. Multifilaments have high tensile breaking strength, but their elemental-strands are prone to buckling deformation in a compression direction, and are pliable with respect to compression and bending. Accordingly, from the perspective of improving bending rigidity, the reinforcing effect of multifilaments can sometimes be low.

The bending rigidity of a crawler in a crawler width direction affects ground contact stability and straight-line travel stability. It is therefore necessary to secure crawler width direction bending rigidity in order to secure ground contact stability and straight-line travel stability.

### SUMMARY

The present invention provides a crawler capable of increasing crawler width direction bending rigidity, and capable of improving ground contact stability and straight-line travel stability.

A crawler of a first aspect of the present invention includes: a crawler body that is formed in an endless shape from an elastic material; a main cord layer that is embedded in the crawler body, and that is configured including one or plural main cords extending along a crawler peripheral direction; and a reinforcement layer that is embedded in the crawler body, and that is configured including plural monofilament cords disposed around the entire crawler peripheral direction at an incline with respect to the crawler peripheral direction.

In the crawler of the first aspect, the reinforcement layer configured including plural monofilaments disposed around the entire crawler peripheral direction at an incline with respect to the crawler peripheral direction is embedded in the crawler body. This thereby enables crawler width direction bending rigidity to be improved over the entire length of the crawler body.

When multifilament cords and monofilament cords of the same diameter are compared, monofilament cords have greater bending rigidity. Accordingly, the crawler body of the first aspect provided with the reinforcement layer configured including monofilament cords is capable of improving the crawler width direction bending rigidity in comparison to a crawler body provided with a reinforcement layer configured including multifilament cords.

Moreover, unlike multifilament cords, monofilament cords do not contain gaps within the cord. Accordingly, water does not enter inside the cord, and so rust does not occur inside the cord.

A crawler of a second aspect of the present invention is the first aspect, wherein the monofilament cords are non-metallic fibers.

In the crawler of the second aspect, the monofilament cords are non-metallic fibers. This thereby enables the occurrence of rust to be prevented.

A crawler of a third aspect of the present invention is the first aspect, wherein the monofilament cords are organic fibers.

In the crawler of the third aspect, the monofilament cords are organic fibers. This thereby enables a reduction in weight, while preventing the occurrence of rust.

A crawler of a fourth aspect of the present invention is the first aspect, wherein the reinforcement layer is provided on a ground contact face side of the main cord layer.

In the crawler of the fourth aspect, the reinforcement layer is provided on the ground contact face side of the main cord layer. External force transmitted to the main cord layer from the ground contact face side is accordingly buffered, thereby enabling the durability of the main cord layer to be improved.

### BRIEF DESCRIPTION OF THE DRAWINGS

Exemplary Embodiments of the present invention will be described in detail based on the following figures, wherein:

FIG. 1 is a side view of a rubber crawler of an exemplary embodiment of the present invention, as viewed from the side of the rubber crawler (along a crawler width direction);

FIG. 2 is a perspective view including a partial cross-section of a rubber crawler of an exemplary embodiment of the present invention; and

FIG. 3 is a perspective view including a partial cross-section illustrating respective cord layers of a rubber crawler of an exemplary embodiment of the present invention.

### DETAILED DESCRIPTION

### First Exemplary Embodiment

Explanation follows regarding a crawler according to a first exemplary embodiment of the present invention.

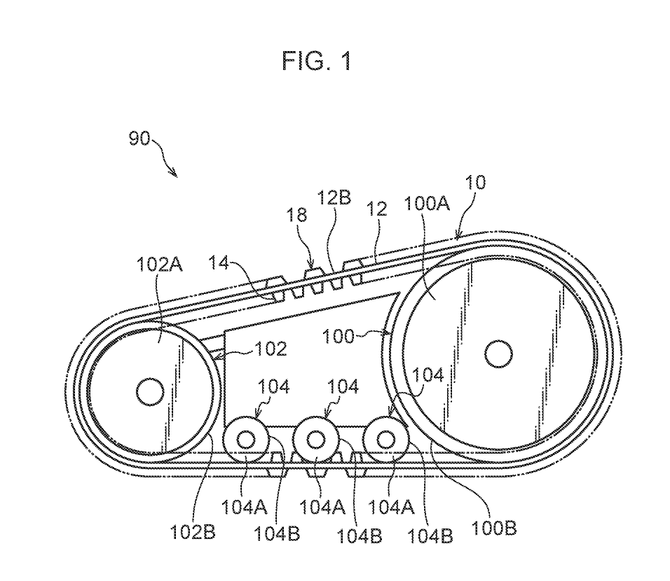

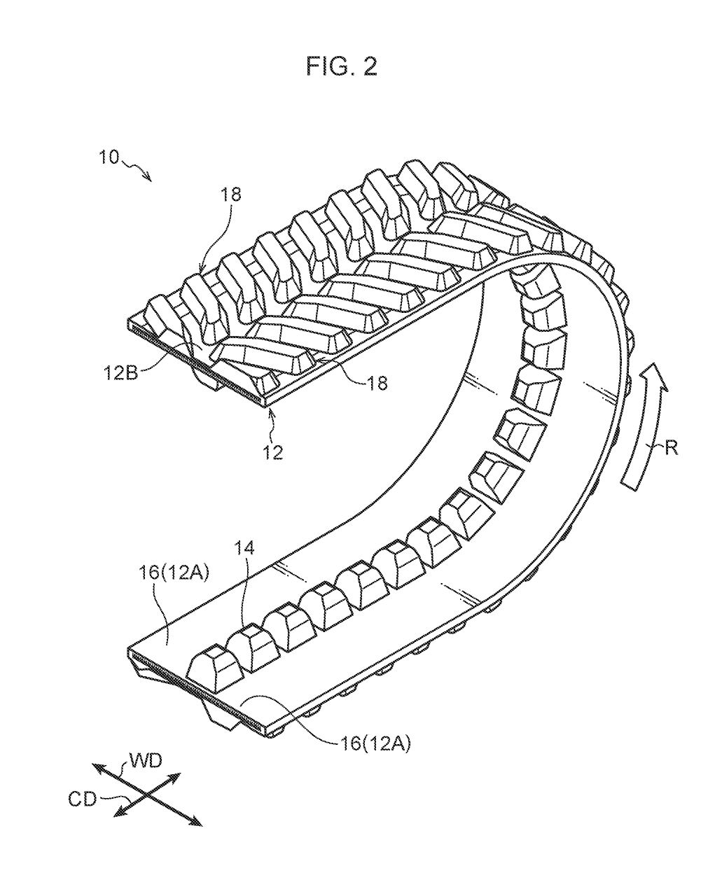

As illustrated in FIG. 1 and FIG. 2, an endless rubber crawler 10, serving as a crawler, according to the first exemplary embodiment of the present invention is what is referred to as a coreless type rubber crawler that does not have a core.

As illustrated in FIG. 1, the rubber crawler 10 is employed entrained around a drive wheel 100 coupled to a drive shaft of a tracked vehicle serving as a vehicle body, and an idle wheel 102 that is attached to the tracked vehicle so as to be freely rotatable. Plural rollers 104, disposed between the drive wheel 100 and the idle wheel 102 and attached to the tracked vehicle so as to be freely rotatable, roll against an inner circumference of the rubber crawler 10.

In the present exemplary embodiment, a peripheral direction (illustrated by the arrow CD in FIG. 2) of the endless rubber crawler 10 is referred to as the “crawler peripheral direction”, and a width direction (illustrated by the arrow WD in FIG. 2) of the rubber crawler 10 is referred to as the “crawler width direction”. Note that the crawler peripheral direction (synonymous with the length direction of the rubber crawler 10) and the crawler width direction are orthogonal to each other as viewed from the peripheral inside or the peripheral outside of the rubber crawler 10.

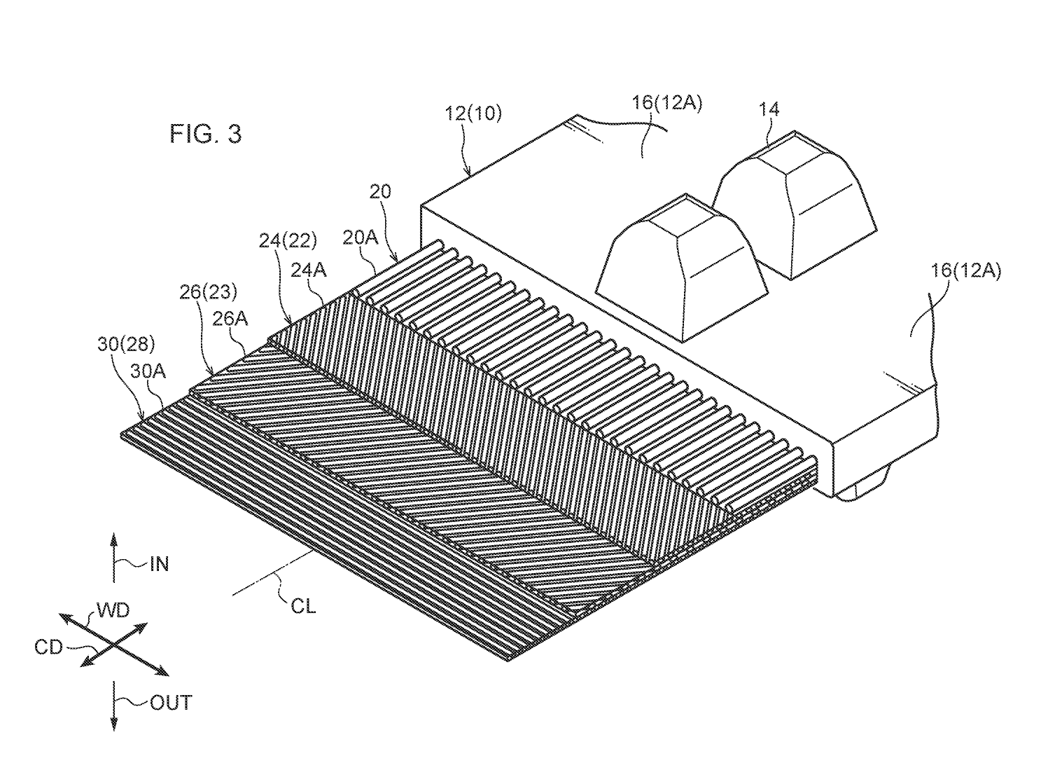

In the present exemplary embodiment, the peripheral inside (the side in the direction indicated by the arrow IN in FIG. 3) of the rubber crawler 10 entrained in an annular shape (encompassing circular annular shapes, elliptical annular shapes, and polygonal annular shapes) around the drive wheel 100 and the idle wheel 102 is referred to as the “crawler peripheral inside”, and the peripheral outside of the rubber crawler 10 (the side in the direction indicated by the arrow OUT in FIG. 3) is referred to as the “crawler peripheral outside”. Note that the arrow IN direction (the direction toward the inside of the annular shape) and the arrow OUT direction (the direction toward the outside of the annular shape) in FIG. 3 indicate an in-out direction of the rubber crawler 10 when in an entrained state (synonymous with a thickness direction of the rubber crawler 10).

The drive wheel 100, the idle wheel 102, the rollers 104, and the rubber crawler 10 entrained thereon configure a crawler traveling device 90 (see FIG. 1), serving as a traveling section of the tracked vehicle.

As illustrated in FIG. 1, the drive wheel 100 includes a pair of circular disk shaped wheel portions 100A that are coupled to the drive shaft of the tracked vehicle. Outer circumferential surfaces 100B of the respective wheel portions 100A contact wheel-rotated faces 16 of a crawler body 12, described later, and roll against the wheel-rotated faces 16. The drive wheel 100 causes drive force from the tracked vehicle to act on the rubber crawler 10 (described in detail later), and circulates the rubber crawler 10 between the drive wheel 100 and the idle wheel 102.

The idle wheel 102 includes a pair of circular disk shaped wheel portions 102A attached to the tracked vehicle so as to be freely rotatable. Outer circumferential surfaces 102B of the respective wheel portions 102A contact the wheel-rotated faces 16, and roll against the wheel-rotated faces 16. The idle wheel 102 is moved in a direction away from the drive wheel 100 and pressed against the wheel-rotated faces 16 by, for example, a hydraulic pressing mechanism, not illustrated in the drawings, provided to the tracked vehicle. Tension (pull) in the rubber crawler 10 entrained around the drive wheel 100 and the idle wheel 102 is maintained by pressing the idle wheel 102 against the wheel-rotated faces 16 in this manner.

The rollers 104 each include a pair of circular disk shaped wheel portions 104A attached to the tracked vehicle so as to be freely rotatable. Outer circumferential surfaces 104B of the respective wheel portions 104A contact the wheel-rotated faces 16 and roll against the wheel-rotated faces 16. The weight of the tracked vehicle is supported by the rollers 104. The idle wheel 102 and the rollers 104 rotate following the rubber crawler 10 circulating between the drive wheel 100 and the idle wheel 102.

Note that the rubber crawler 10 (crawler body 12) is entrained around the drive wheel 100 and the idle wheel 102 under a specific tension. Accordingly, frictional force arises between the outer circumferential surfaces 100B of the drive wheel 100 and the wheel-rotated faces 16, transmitting drive force of the drive wheel 100 to the rubber crawler 10, and circulating the rubber crawler 10 between the drive wheel 100 and the idle wheel 102 such that the rubber crawler 10 travels.

As illustrated in FIG. 1 and FIG. 2, the rubber crawler 10 includes the crawler body 12 configured by forming a rubber material, this being an example of an elastic material, into an endless belt shape. Note that the crawler body 12 of the present exemplary embodiment is an example of an endless belt shaped crawler body of the present invention. The peripheral direction, the width direction, the peripheral inside, and the peripheral outside of the crawler body 12 of the present exemplary embodiment respectively match the crawler peripheral direction, the crawler width direction, the crawler peripheral inside, and the crawler peripheral outside.

As illustrated in FIG. 2 and FIG. 3, at intervals around the crawler peripheral direction, the crawler body 12 is formed with plural rubber projections 14 projecting out from an inner peripheral surface 12A toward the crawler peripheral inside. The rubber projections 14 are disposed along a central line CL passing through the crawler width direction center of the crawler body 12. The rubber projections 14 restrict movement of the wheels in the crawler width direction by contacting the wheels (referring to the drive wheel 100, the idle wheel 102, and the rollers 104) rolling against the wheel-rotated faces 16. In other words, by contacting the wheels, the rubber projections 14 are capable of suppressing relative movement in the crawler width direction between the rubber crawler 10 and the wheels. Namely, the rubber projections 14 are capable of suppressing lateral slippage of the rubber crawler 10 with respect to the wheels.

As illustrated in FIG. 2, the respective wheel-rotated faces 16 are formed extending along the crawler peripheral direction at the crawler width direction outside of the crawler body 12, on both sides of the rubber projections 14. The wheel-rotated faces 16 are configured with flat profiles, and configure a portion of the inner peripheral surface 12A of the crawler body 12.

As illustrated in FIG. 1 and FIG. 2, the crawler body 12 is provided with plural lugs 18 projecting out from an outer peripheral surface 12B toward the crawler peripheral outside.

Cord Layer

As illustrated in FIG. 3, a main cord layer 20, a first bias cord layer 22, a second bias cord layer 23, and a reinforcement layer 28 are embedded in the crawler body 12 in the above sequence from the crawler peripheral inside.

The main cord layer 20 is configured in an endless belt shape, and is provided with main cords 20A extending in the crawler peripheral direction. The main cord layer 20 may be configured by disposing plural of the main cords 20A in a slatted pattern, or may be configured by winding one or plural of the main cords 20A around and around. Note that in the present exemplary embodiment, the main cords 20A are disposed at a central portion in the thickness direction of the crawler body 12 (synonymous with the crawler in-out direction).

Each main cord 20A is configured by twisting together plural strands. Note that in the present exemplary embodiment, as an example, each of the strands is formed by winding together plural steel filaments. However, the present invention is not limited to such a configuration. The main cords 20A are coated with rubber.

The first bias cord layer 22 is configured in an endless belt shape, and is superimposed on the main cord layer 20 at the crawler peripheral outside thereof. The first bias cord layer 22 includes an endless belt shaped bias ply 24 formed by embedding bias cords 24A in belt shaped rubber, such that the bias cords 24A extend at an incline with respect to the crawler peripheral direction and plural of the bias cords 24A lie side-by-side in the crawler peripheral direction. Note that bias cords 24A of the present exemplary embodiment are multifilament cords, each configured including plural steel elemental-strands.

The second bias cord layer 23 is configured in an endless belt shape, and is superimposed on the first bias cord layer 22 at the crawler peripheral outside thereof. The second bias cord layer 23 includes an endless belt shaped bias ply 26 formed by embedding bias cords 26A in belt shaped rubber, such that the bias cords 26A extend at an incline with respect to the crawler peripheral direction and intersect the bias cords 24A, and plural of the bias cords 26A lie side-by-side in the crawler peripheral direction. Specifically, the bias cords 26A are inclined in the opposite direction to the bias cords 24A with respect to the crawler peripheral direction. Note that the bias cords 26A of the present exemplary embodiment are multifilament cords, each configured including plural steel elemental-strands.

In the present exemplary embodiment, the bias cords 24A and the bias cords 26A are configured by similar steel cords. The bias cords 24A and the bias cords 26A employ steel cords with a smaller diameter than the main cords 20A, from the perspective of the bending flexibility of the rubber crawler 10.

The reinforcement layer 28 is configured in an endless belt shape, and is superimposed on the second bias cord layer 23 at the crawler peripheral outside thereof. The reinforcement layer 28 is formed from an endless belt shaped reinforcement ply 30.

The reinforcement ply 30 is formed by embedding reinforcement cords 30A in belt shaped rubber, such that the reinforcement cords 30A extend in the crawler width direction (in other words, a direction orthogonal to the central line CL), and plural of the reinforcement cords 30A lie side-by-side at a specific spacing around the entire crawler peripheral direction. Note that here, “extending in the crawler width direction” encompasses cases inclined by approximately ±3° with respect to the crawler width direction. In the present exemplary embodiment, the “layer” of the “reinforcement layer 28”, refers to the spacing between one of the reinforcement cords 30A and another of the reinforcement cords 30A disposed around the peripheral direction being from 0 mm (0 mm being a case in which the reinforcement cords 30A contact each other) to 20 mm, and preferably being from 0.1 mm to 15 mm.

The reinforcement cords 30A of the present exemplary embodiment employ monofilament cords, each configured from a single steel fiber. The reinforcement cords 30A extend in the crawler width direction, and the reinforcement ply 30 has high bending rigidity in the crawler width direction. In other words, the reinforcement ply 30 does not readily undergo bending deformation in the crawler width direction.

Operation and Advantageous Effects

Next, explanation follows regarding operation and advantageous effects of the rubber crawler 10 of the present exemplary embodiment.

Employing monofilament reinforcement cords 30A enables the bending rigidity of the reinforcement cords 30A to be raised in comparison to cases employing multifilaments of the same diameter and the same materials, and also makes buckling deformation less liable to occur. Accordingly, the bending rigidity of the crawler body 12 in the crawler width direction can be increased, making the crawler body 12 less liable to deform in the crawler width direction. This thereby enables the ground contact stability and straight-line travel performance of the crawler body 12 to be improved.

Moreover, since employing monofilament reinforcement cords 30A enables the bending rigidity of the reinforcement cords 30A to be raised in comparison to cases employing multifilaments of the same diameter and the same materials, the diameter of the reinforcement cords 30A can be made thinner than in cases employing multifilaments, and the number of reinforcement cords 30A incorporated in the reinforcement layer 28 can be reduced. This thereby enables a reduction in weight of the crawler body 12.

Moreover, making the diameter of the reinforcement cords 30A thinner enables a spacing between the reinforcement cords 30A and the bias cords 26A adjacent to the reinforcement cords 30A to be made wider, without modifying the distance between the centers of the reinforcement cords 30A and the bias cords 26A adjacent to the reinforcement cords 30A. This thereby renders the reinforcement cords 30A and the bias cords 26A less liable to make contact with each other.

Moreover, monofilaments are less liable to break as a result of wear than multifilaments of equivalent diameter. Accordingly, the reinforcement cords 30A are less liable to break as a result of wear when configured by monofilaments than when configured by multifilaments.

Moreover, unlike multifilaments, monofilaments do not contain gaps within the cord. Accordingly, unlike multifilaments, water does not get trapped within the cord, thereby making it more difficult for rust to progress inside the cord.

In the rubber crawler 10, the reinforcement layer 28 is disposed at the crawler peripheral outside of the second bias cord layer 23. External force transmitted to the main cord layer 20 from a ground contact face side is accordingly buffered, thereby enabling the durability of the main cord layer 20 to be improved. Moreover, the speed with which cracks resulting from external damage to the outer peripheral surface 12B of the crawler body 12 progress as far as the first bias cord layer 22 and the second bias cord layer 23 can be slowed.

The reinforcement layer 28 is a layer configured by the reinforcement ply 30, in which the reinforcement cords 30A are disposed at the specific spacing around the entire crawler peripheral direction. This thereby enables the crawler width direction bending rigidity of the reinforcement layer 28 to be made uniform around the crawler peripheral direction, and also enables external force transmitted to the main cord layer 20 from the ground contact face side to be reliably buffered. Note that if the spacing between the reinforcement cords 30A in the crawler peripheral direction were to become too wide, there is a possibility that the crawler width direction bending rigidity could become non-uniform in the crawler peripheral direction, and the buffering effect with respect to external force transmitted to the main cord layer 20 from the ground contact face side could become inadequate.

### Second Exemplary Embodiment

In the first exemplary embodiment, steel monofilaments are employed for the reinforcement cords 30A. However, the present invention is not limited thereto. A material other than steel may be employed for the reinforcement cords 30A, as long as sufficient crawler width direction bending rigidity can be secured.

Materials that may be employed for the reinforcement cords 30A include, for example, metal materials other than steel, such as an alloy of iron or an alloy of copper, metal oxides such as alumina, organic materials such as an aliphatic polyamide, polyester, or aromatic polyamide, and inorganic materials other than metals, such as carbon. In order to suppress the occurrence of rust, it is preferable to employ a monofilament configured from an organic material, or an inorganic material other than a metal, for the reinforcement cords 30A. Employing a monofilament configured from an organic material, or an inorganic material other than a metal, for the reinforcement cords 30A also enables a reduction in weight in comparison to cases in which a metal material is employed, while still securing bending rigidity.

### Third Exemplary Embodiment

In the first exemplary embodiment, the bias cords 24A of the bias ply 24 and the bias cords 26A of the bias ply 26 are multifilament cords. However, in a third exemplary embodiment, the bias cords 24A of the bias ply 24 and the bias cords 26A of the bias ply 26 are configured by monofilament cords, similarly to the reinforcement cords 30A of the reinforcement ply 30. This thereby enables the crawler width direction bending rigidity to be further improved. Moreover, as long as they have sufficient tensile breaking strength, the material of the bias cords 24A and the bias cords 26A is not limited to steel, and may be an organic material (for example an aliphatic polyamide, polyester, or aromatic polyamide), a metal oxide such as alumina, or an inorganic material other than a metal.

### Fourth Exemplary Embodiment

In the first exemplary embodiment, the reinforcement layer 28 is disposed on an outer peripheral surface side (ground contact face side) of the main cord layer 20. However, the reinforcement layer 28 may be provided on the crawler peripheral inside of the main cord layer 20. This enables external force transmitted to the main cords 20A from the drive wheel 100 or the idle wheel 102 to be buffered, enabling the durability of the main cords 20A to be improved. Note that from the perspective of protecting the other layers, the reinforcement layer 28 is preferably provided as an outermost layer or an innermost layer, and two or more of the reinforcement layers 28 may be provided.

Explanation has been given regarding exemplary embodiments for implementing the present invention; however, these exemplary embodiments are merely examples, and various modifications may be implemented within a range not departing from the spirit of the present invention. Obviously, the scope of rights encompassed by the present invention is not limited to these exemplary embodiments.

In the exemplary embodiments described above, the main cord layer 20, the first bias cord layer 22, the second bias cord layer 23, and the reinforcement layer 28 are embedded in the crawler body 12 in that sequence from the crawler peripheral inside. However, the present invention is not limited to such a configuration. For example, the sequence of the respective cord layers may be modified.

In the exemplary embodiments described above, the main cords 20A are configured by steel cords. However, the present invention is not limited to such a configuration, and organic fiber cords configured by an organic fiber (for example an aliphatic polyamide fiber, a polyester fiber, or an aromatic polyamide fiber) may be employed for the main cords 20A as long as they have sufficient tensile breaking strength.

Table 1 below shows the nominal diameter, bending rigidity, tensile breaking strength, and linear density of various cords for reference. The monofilaments in the table may be employed as the reinforcement cords 30A. Employing the monofilaments in the table enables improved bending rigidity of the reinforcement cords 30A in comparison to when multifilament steel cords are employed. Note that a material with a bending rigidity of 686N·mm² or greater is preferably employed for the reinforcement cords 30A.

| | | | | Tensile | |
|---|---|---|---|---|---|
| | | | | breaking | |
| | | Nominal | Bending | strength | Linear |
| | | diameter | rigidity | (load) | density |
| | Structure | (mm) | N · mm² | kgf | g/m |
| Steel cord | 3 × 0.24/9 × | 0.94 | 662 | 150 | 4.1 |
| (multi- | 0.225 + 0.5 | | | | |
| filament) | | | | | |
| Steel | | 0.8 | 4165 | 130 | 5.4 |
| mono- | | | | | |
| filament | | | | | |
| Polyester | | 1 | 686 | 27 | 1 |
| mono- | | | | | |
| filament | | | | | |
| Aliphatic | | 1.5 | 1989 | 50 | 3.3 |
| polyamide | | | | | |
| mono- | | | | | |
| filament | | | | | |
| Polyester | | 1.5 | 3724 | 61 | 4 |
| mono- | | | | | |
| filament | | | | | |

What is claimed is:

1. A crawler comprising:
a crawler body that is formed in an endless shape from an elastic material;
a main cord layer that is embedded in the crawler body, and that is configured including one or a plurality of main cords extending along a crawler peripheral direction; and
a reinforcement layer that is embedded in the crawler body, and that is configured including a plurality of monofilament cords disposed around the entire crawler peripheral direction so as to intersect the main cord direction.

2. The crawler of claim 1, wherein the monofilament cords are non-metallic fibers.

3. The crawler of claim 1, wherein the monofilament cords are organic fibers.

4. The crawler of claim 1, wherein the reinforcement layer is provided on a ground contact face side of the main cord layer.
